(19) United States
(12) Patent Application Publication
(10) Pub. No.: US 2025/0263078 A1
(43) Pub. Date: Aug. 21, 2025

(54) VEHICLE AND METHOD OF CONTROLLING THE SAME

(71) Applicant: HL KLEMOVE CORP., Incheon (KR)

(72) Inventor: Jun Min LEE, Incheon (KR)

(21) Appl. No.: 18/885,691

(22) Filed: Sep. 15, 2024

(30) Foreign Application Priority Data
Feb. 19, 2024 (KR) 10-2024-0023294

(51) Int. Cl. B60W 40/076; B60R 11/00

(52) U.S. Cl. CPC B60W 40/076; B60R 2011/0084; B60R 2011/0085

(57) ABSTRACT

A vehicle and a method of controlling the same are disclosed. The vehicle according to an aspect of the present disclosure includes a vehicle body; an environment sensor configured to generate environment detection information on an external environment; a support member coupled to the vehicle body and the environment sensor, respectively; and an actuator coupled to the vehicle body and one part of the support member, respectively, and configured to move the one part of the support member in a direction toward the vehicle body and a direction opposite to the vehicle body, wherein one side of the support member in a height direction is coupled to the actuator, and the other side of the support member in the height direction is rotatably coupled to the vehicle body, so that when the actuator is operated, the environment sensor rotates clockwise or counterclockwise about the other side of the support member.

### CROSS-REFERENCE TO RELATED APPLICATION

This application claims priority to and the benefit of Korean Patent Application No. 10-2024-0023294, filed on Feb. 19, 2024, the disclosures of which is incorporated herein by reference in its entirety.

### FIELD

The present disclosure relates to a vehicle and method of controlling the same, and more particularly, to a vehicle in which an area recognized by components for autonomous driving may be actively adjusted when the vehicle enters a slope road while driven, and a method of controlling the same.

### BACKGROUND

Light Detection And Ranging (LIDAR) is a radar system that measures the distance to the outside using a laser pulse. The LIDAR device radiates laser light to the surrounding area and measures the time it takes for it to reflect outside and return to measure the distance to the outside and the shape of the measurement object.

Recently, the LIDAR device has be used in various technical fields such as mobile robots. In particular, the LIDAR device is actively applied to a vehicle for driver assistance and autonomous driving. The LIDAR device installed in the vehicle plays a very important role in recognizing objects present in the surrounding environment while the vehicle is driven.

The LIDAR device may recognize objects located at a predetermined field of view (FOV). In this case, the FOV of the LIDAR sensor is formed to have a fixed FOV in the height direction, that is, up and down directions or in the width direction, that is, left and right directions.

Meanwhile, when the LIDAR sensor is arbitrarily moved or rotated, the accuracy of the information collected may be deteriorated. Therefore, it is general that the LIDAR sensor is fixedly installed in a frame of the vehicle or the like.

Meanwhile, the road on which the vehicle is driven may be largely divided into a flat surface and a slope surface. When the vehicle is driven on the flat surface, the LIDAR device recognizes the object located within the predetermined FOA, and the vehicle's driving may be controlled according to the result. On the other hand, when the vehicle enters the slope surface, a situation may occur in which the LIDAR device may not accurately recognize the object.

Specifically, before the vehicle enters the slope surface, the LIDAR device may recognize that there is a slope surface on the front side. However, at the moment when the vehicle enters the slope surface and after the vehicle enters the slope surface, the FOA of the LIDAR device is fixed the same as when driven on the flat surface, so that some of the recognized objects may be missed. In this case, there is a concern that the accuracy and safety of the autonomous driving may be deteriorated.

Korean Patent Registration No. 10-2515614 discloses a system and method for adjusting the field of view of a sensor. More specifically, disclosed are a system and method for adjusting a field of view of a sensor by separately utilizing information related to an autonomous driving map for a moving route from a departure point to a destination point of a driving vehicle.

However, the system and method for adjusting the field of view of the sensor disclosed in the above prior document require additional information related to an autonomous driving map. Except for the case where the information is directly stored in the vehicle, when it is obtained by communication with the outside, there is a risk that immediate adjustment will not be possible depending on the communication status.

Korean Patent Registration No. 10-2343020 discloses a position signal correction device of an autonomous vehicle using road surface image information. More specifically, disclosed is a position signal correction device capable of correcting a GPS position signal of an autonomous vehicle by using image information of a road surface acquired during the driving.

However, the position signal correction device disclosed in the above prior document provides only a method for accurately determining the position of a driving vehicle. That is, the prior document does not provide a method for recognizing the entrance of the slope surface and adjusting the field of view (FOV) of the sensor.
(Patent document 1) Korean Patent Registration No. 10-2515614 (2023 Mar. 24)
(Patent document 2) Korean Patent Registration No. 10-2343020 (2021 Dec. 21)

### SUMMARY

### Technical Problem

The present disclosure is to solve the above problems, and an object of the present disclosure is to provide a vehicle for actively adjusting a field of view (FOV) of a component that detects information on an external environment according to a slope of a ground on which the vehicle is driven, and a method of controlling the same.

Another object of the present disclosure is to provide a vehicle for accurately detecting whether the vehicle enters a slope surface, and a method of controlling the same.

Still another object of the present disclosure is to provide a vehicle for accurately detecting information on an external environment in which the vehicle is driven, and a method of controlling the same.

Still another object of the present disclosure is to provide a vehicle for easily providing a component for detecting information on an external environment, and a method of controlling the same.

Still another object of the present disclosure is to provide a vehicle for achieving the above objects in a simplified structure, and a method of controlling the same.

The technical objects of the present disclosure are not limited to the above-mentioned technical objects, and other technical objects not mentioned may be clearly understood by those skilled in the art to which the present disclosure pertains from the following description.

### Technical Solution

According to an aspect of the present disclosure, there is provided a vehicle, the vehicle including: a vehicle body; an environment sensor configured to generate environment detection information on an external environment; a support member coupled to the vehicle body and the environment sensor, respectively; and an actuator coupled to the vehicle body and one part of the support member, respectively, and configured to move the one part of the support member in a direction toward the vehicle body and a direction opposite to the vehicle body, wherein one side of the support member in a height direction is coupled to the actuator, and the other side of the support member in the height direction is rotatably coupled to the vehicle body, so that when the actuator is operated, the environment sensor rotates clockwise or counterclockwise about the other side of the support member.

In this case, a vehicle may be provided wherein the support member includes: a bracket member coupled to the environment sensor; a variable shaft coupled to one side of the bracket member in the height direction and the actuator, respectively; and a fixed shaft coupled to the other side of the bracket member in the height direction and the vehicle body, respectively.

In addition, a vehicle may be provided wherein the variable shaft and the fixed shaft are rotatably coupled to the bracket member, respectively, and the environment sensor is fixedly coupled to the bracket member to rotate clockwise or counterclockwise about a portion where the fixed shaft and the bracket member are coupled.

In this case, a vehicle may be provided, including: a controller electrically connected to the environment sensor and the actuator, respectively, and configured to control the actuator using the generated environment detection information.

In addition, a vehicle may be provided, wherein the controller control the actuator to move the support member in a direction toward the vehicle body such that the environment sensor is tilted upward when the generated environment detection information means that a first slope surface is located on a front side.

In this case, a vehicle may be provided, including: an inclination sensor electrically connected to the controller and configured to generate inclination detection information on a slope of a surface on which the vehicle is located, wherein the controller controls the actuator to move the support member in a direction opposite to the vehicle body such that the environment sensor is tilted downward when the inclination detection information generated after entering the first slope surface is less than a predetermined first angle.

In addition, a vehicle may be provided, wherein the controller controls the actuator to move the support member in a direction opposite to the vehicle body such that the environment sensor is tilted downward when the generated environment detection information means that a second slope surface is located on a front side.

In this case, a vehicle may be provided, including: an inclination sensor electrically connected to the controller and configured to generate inclination detection information on a slope of a surface on which the vehicle is located, wherein the controller controls the actuator to move the support member in a direction toward the vehicle body such that the environment sensor is tilted upward when the inclination detection information generated after entering the second slope surface is less than a predetermined second angle.

In addition, a vehicle may be provided, including: an inclination sensor electrically connected to the controller and configured to generate inclination detection information on a slope of a surface on which the vehicle is located, wherein the controller calculates control information for controlling the actuator using only the environment detection information when the generated environment detection information means that a flat surface is located on a front side, and the generated inclination detection information means that a first slope surface or a second slope surface is located on the front side.

In this case, a vehicle may be provided, wherein the environment sensor includes one or more of a LIDAR sensor, a camera sensor, and a 4D imaging radar sensor.

In addition, according to an aspect of the present disclosure, there is provided a method of controlling a vehicle, the method including: (a) generating, by an environment sensor provided in a vehicle, environment detection information on an external environment; (b) controlling, by a controller, an actuator coupled with the environment sensor using the generated environment detection information; (c) generating, by an inclination sensor, inclination detection information on a slope on which the vehicle is disposed; and (d) controlling, by the controller, the actuator using the generated inclination detection information.

In this case, there is provided a method of controlling a vehicle, wherein the step (a) includes: (a1) generating, by the environment sensor, the environment detection information on a slope of a road located on a front side thereof; and (a2) transmitting, by the environment sensor, the generated environment detection information to the controller.

In addition, there is provided a method of controlling a vehicle, wherein the step (b) includes: (b1) controlling, by the controller, the actuator to maintain an angle of the environment sensor, when the generated environment detection information means that a road located on a front side is a flat surface; (b2) controlling, by the controller, the actuator to tilt the environment sensor upward, when the generated environment detection information means that a road located on a front side is a first slope surface; and (b3) controlling, by the controller, the actuator to tilt the environment sensor downward, when the generated environment detection information means that a road located on a front side is a second slope surface.

In this case, there is provided a method of controlling a vehicle, wherein the step (b) further includes before the steps (b1) to (b3): (b0) generating, by the inclination sensor, the inclination detection information on an angle at which the vehicle is disposed, and wherein the step (b1) includes: (b11) controlling, by the controller, the actuator to maintain the angle of the environment sensor regardless of the generated inclination detection information.

In addition, there is provided a method of controlling a vehicle, wherein the step (d) includes: (d1) controlling, by the controller, the actuator to tilt the environment sensor downward, when the inclination detection information generated while the environment sensor is tilted upward is less than a predetermined first angle; and (d2) controlling, by the controller, the actuator to tilt the environment sensor upward when the inclination detection information generated while the environment sensor is tilted downward is less than a predetermined second angle.

### Advantageous Effects

According to the above configuration, the vehicle and method of controlling the same according to an embodiment of the present disclosure can actively adjust a field of view (FOV) of a component that detects information on an external environment according to a slope of a ground on which the vehicle is driven.

Additionally, according to the above configuration, the vehicle and method of controlling the same according to an embodiment of the present disclosure can accurately detect whether the vehicle enters a slope surface.

Additionally, according to the above configuration, the vehicle and method of controlling the same according to an embodiment of the present disclosure can accurately detect information on an external environment in which the vehicle is driven.

Additionally, according to the above configuration, the vehicle and method of controlling the same according to an embodiment of the present disclosure can easily provide a component for detecting information on an external environment.

Additionally, according to the above configuration, the vehicle and method of controlling the same according to an embodiment of the present disclosure can achieve the above objects in a simplified structure.

It should be understood that the effects of the present disclosure are not limited to the above effects, and include all effects that can be inferred from the detailed description of the present disclosure or the configuration of the invention described in the claims.

### BRIEF DESCRIPTION OF THE DRAWINGS

FIG. 1 is a block diagram illustrating a connection relationship between components of a vehicle according to an embodiment of the present disclosure.

FIG. 2 is a conceptual diagram illustrating a state in which each component provided in the vehicle of FIG. 1 is adjusted to a first position.

FIG. 3 is a conceptual diagram illustrating a state in which each component provided in the vehicle of FIG. 1 is adjusted to a second position.

FIG. 4 is a conceptual diagram illustrating a state in which each component provided in the vehicle of FIG. 1 is adjusted to a third position.

FIGS. 5 to 7 are state diagrams illustrating a process of adjusting a position of each component when the vehicle of FIG. 1 is driven toward a first slope surface.

FIGS. 8 to 10 are state diagrams illustrating a process of adjusting a position of each component when the vehicle of FIG. 1 is driven toward a second slope surface.

FIG. 11 is a flowchart illustrating a flow of a method of controlling a vehicle according to an embodiment of the present disclosure.

FIG. 12 is a flowchart illustrating a detailed flow of step S100 in the method of controlling the vehicle of FIG. 11.

FIG. 13 is a flowchart illustrating a detailed flow of step S200 in the method of controlling the vehicle of FIG. 11.

FIG. 14 is a flowchart illustrating a detailed flow of step S400 in the method of controlling the vehicle of FIG. 11.

### DETAILED DESCRIPTION

Hereinafter, embodiments of the present disclosure will be described in detail with reference to the accompanying drawings so that those skilled in the art can easily carry out the present disclosure. The present disclosure may be embodied in various different forms and is not limited to the embodiments described herein. In order to clearly describe the present disclosure, parts not related to the description are omitted in the drawings, and the same or similar components are denoted by the same reference numerals throughout the specification.

The words and terms used in the specification and the claims are not to be construed as limited to ordinary or dictionary meanings, but should be construed as meanings and concepts corresponding to technical aspects of the present disclosure according to principles capable of defining terms and concepts by the inventor in order to describe the present disclosure in the best way.

Therefore, the embodiments described in the specification and the configurations illustrated in the drawings correspond to a preferred embodiment of the present disclosure and do not represent all the technical aspects of the present disclosure, and thus the corresponding configurations may have various equivalents and modifications to substitute them at the time of filing the present disclosure.

In the following description, some components may be omitted to clarify the features of the present disclosure.

The term “electrical connection” used in the following description means that one or more members are connected to each other to transmit a current or an electric signal. In an embodiment, the electrical connection may be formed in a wired form by a wire member or the like or in a wireless form such as Bluetooth, Wi-Fi, or RFID. In an embodiment, the electrical connection may include the meaning of “communication”.

The term “front side” used in the following description means the direction in which the vehicle 10 is driven, and the term “rear side” means the direction in which the vehicle 10 has already been driven. In addition, the term “upper side” means the direction away from a flat surface, and the term “lower side” means the direction toward the flat surface.

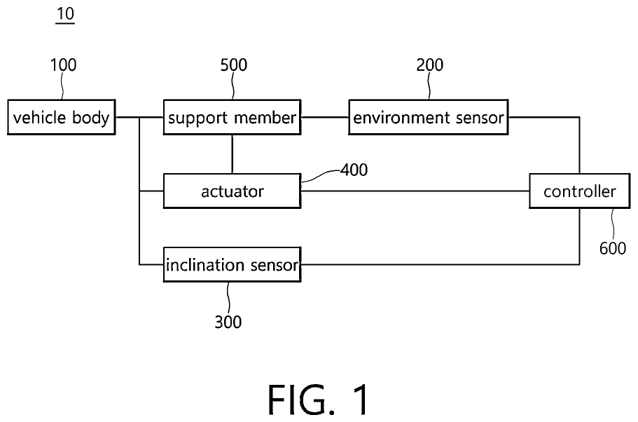

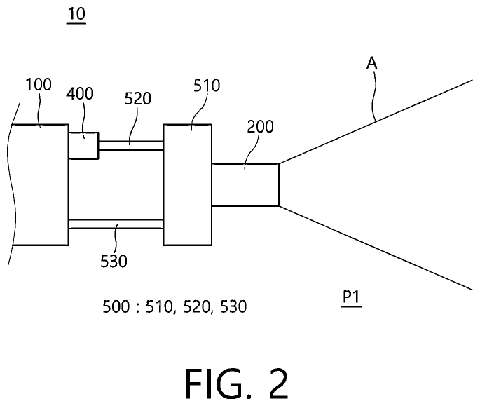

Referring to FIGS. 1 and 2, each component of the vehicle 10 and a coupling relationship between them according to the embodiment of the present disclosure are illustrated as examples.

The vehicle 10 according to the embodiment of the present disclosure is provided with a component for generating environment detection information on an external environment. The environment detection information generated by the component may be transmitted to another component and used for autonomous driving of the vehicle 10.

It is assumed that the vehicle 10 according to an embodiment of the present disclosure is a general vehicle provided for passenger use or cargo loading. However, the vehicle 10 according to an embodiment of the present disclosure may be equipped with any device capable of autonomously driving in response to an external environment such as an autonomous driving robot.

In the illustrated embodiment, the vehicle 10 includes a vehicle body 100, an environment sensor 200, an inclination sensor 300, an actuator 400, a support member 500, and a controller 600.

The vehicle body 100 constitutes the external shape of the vehicle 10. The vehicle body 100 is a part where the vehicle 10 is exposed to the outside. The vehicle body 100 is made of a high-rigidity material and may protect passengers or cargo inside.

The vehicle body 100 may be equipped to be driven. To this end, the vehicle body 100 may include components such as wheels.

The vehicle body 100 is coupled with the environment sensor 200. The environment sensor 200 generates environment detection information on the environment in the direction in which the vehicle body 100 is driving, that is, the front side. In an embodiment, the environment sensor 200 may be located outside the vehicle body 100. In the above embodiment, the environment sensor 200 may be disposed on a loop or grill provided on the vehicle body 100.

The vehicle body 100 is combined with the inclination sensor 300. The inclination sensor 300 generates inclination detection information on the angle of the driving position of the vehicle body 100.

The vehicle body 100 is combined with the actuator 400. The vehicle body 100 may support the actuator 400. Accordingly, when the actuator 400 is operated, the support member 500 coupled thereto may be moved.

The vehicle body 100 is combined with the support member 500. At this time, some components of the support member 500 may be coupled to the vehicle body 100 through the actuator 400. In addition, the other components of the support member 500 may be directly coupled to and supported by the vehicle body 100.

As will be described later, some of the above components of support member 500 may be moved by actuator 400. Additionally, the other components of the support member 500 may be maintained at a fixedly coupled state to the vehicle body 100. Accordingly, the field of view (FOV) of the environment sensor 200 may be adjusted, which will be described in detail later.

A controller 600 may be coupled to the vehicle body 100. The vehicle body 100 may accommodate or support the controller 600. Various electrical components provided in the vehicle body 100 may be electrically connected to the controller 600 and controlled by the controller 600.

The environment sensor 200 generates environment detection information on the direction in which the vehicle 10 will be driven, that is, the environment on the front side. The environment detection information generated by the environment sensor 200 may be transmitted to the controller 600 and used as a basis for controlling the driving of the vehicle 10.

The environment sensor 200 may be formed to have a predetermined field of view (FOV). The FOV may be formed to have a predetermined size along the height direction of the vehicle 10, that is, the up and down directions, or the width direction of the vehicle 10, that is, the left and right directions. In the following description, the FOV of the environment sensor 200 is described based on the FOV of the height direction.

The size of the FOV of the environment sensor 200 may be a fixed value. In other words, the environment sensor 200 may generate environment detection information on the detecting area (A) as much as the FOV of a predetermined size.

Therefore, while the vehicle 10 is driving on a flat surface (F), the environment sensor 200 may accurately generate environment detection information on the external environment of the vehicle 10. On the other hand, at the moment when the vehicle 10 enters the slope surfaces (S1, and S2), some of the spaces on the front side of the vehicle 10 are excluded from the detecting area (A), so that the accuracy of environment detection information for the external environment is reduced.

Accordingly, the vehicle 10 according to an embodiment of the present disclosure is configured to adjust the angle itself at which the environment sensor 200 is coupled to the vehicle body 100. At this time, the angle formed between the environment sensor 200 and the vehicle body 100 may be adjusted again after entering the slope surfaces (S1, and S2). Accordingly, no matter whether the vehicle 10 drives on a flat surface (F) or a slope surfaces (S1, and S2), environment detection information on the external environment can be accurately generated.

The environment sensor 200 may be provided in any form capable of generating environment detection information on the external environment of the vehicle 10. In one embodiment, the environment sensor 200 may be equipped with a LIDAR sensor, a camera sensor, a 4D imaging radar sensor, etc.

The environment sensor 200 may be supported by being coupled to the vehicle body 100. As described above, the environment sensor 200 may be exposed to the outside of the vehicle body 100.

The environment sensor 200 is coupled with the actuator 400. Specifically, the environment sensor 200 is movably coupled to the actuator 400 by the support member 500. The relative angle between the environment sensor 200 and the vehicle body 100 may be adjusted by moving the actuator 400 and the support member 500 coupled thereto.

The environment sensor 200 is electrically connected to the controller 600. The environment detection information generated by the environment sensor 200 may be transmitted to the controller 600 and utilized to control each component of the vehicle 10, especially the actuator 400.

The inclination sensor 300 generates inclination detection information on the slope of the surface on which the vehicle 10 is driven. The inclination detection information generated by the inclination sensor 300 may be transmitted to the controller 600 and utilized as a basis for controlling the driving of the vehicle 10. In addition, the inclination detection information generated by the inclination sensor 300 may be utilized to control each component of the vehicle 10, particularly the actuator 400.

The inclination sensor 300 may be provided in any form capable of generating inclination detection information on the slope of the surface on which the vehicle 10 is located. In one embodiment, the inclination sensor 300 may be equipped with an Inertial Measurement Unit (IMU) sensor or a gyro sensor, etc.

The inclination sensor 300 is electrically connected to the controller 600. The inclination detection information generated by the inclination sensor 300 may be transmitted to the controller 600 and utilized to control each component of the vehicle 10, especially the actuator 400.

The actuator 400 is coupled to the vehicle body 100 and the support member 500. The actuator 400 moves the support member 500 and the environment sensor 200 coupled thereto relative to the vehicle body 100. Accordingly, the angle of the environment sensor 200 may be adjusted and the position of the detecting area (A) may also be changed.

The actuator 400 is coupled to the vehicle body 100. One side of the actuator 400, in the illustrated embodiment, the rear side may be fixedly coupled to the vehicle body 100. Accordingly, it will be understood that when the actuator 400 is operated, only the support member 500 and the environment sensor 200 coupled thereto are moved.

In this case, the height at which the actuator 400 is coupled with the vehicle body 100 may be determined corresponding to the height of the variable shaft 520. In the illustrated embodiment, the actuator 400 is coupled to the upper side of the vehicle body 100.

The actuator 400 is coupled to the support member 500. The other side of the actuator 400, in the illustrated embodiment, the front side, may be coupled to the support member 500. The actuator 400 may move the support member 500 in any direction. In one embodiment, the actuator 400 may move the support member 500 in the front and rear directions.

At this time, the support member 500 includes a pair of shafts 520 and 530 that are spaced apart in the height direction of the vehicle 10, that is, in the up and down directions. The actuator 400 is coupled to a variable shaft 520 located on one side in the height direction, in the illustrated embodiment, on the upper side. When the actuator 400 is operated, only the variable shaft 520 may be moved while the length of the other shaft 530, that is, the fixed shaft 530, is maintained.

The actuator 400 is electrically connected to the controller 600. The actuator 400 may be controlled corresponding to control information calculated by the controller 600.

The actuator 400 is controlled by the controller 600 and may be provided in any form capable of moving the support member 500 and the environment sensor 200 coupled thereto. In one embodiment, the actuator 400 may be provided in the form of a motor or hydraulic cylinder.

The support member 500 movably supports the environment sensor 200. The support member 500 is coupled with the actuator 400 and may move together with the environment sensor 200 according to the operation of the actuator 400.

The support member 500 is coupled to the vehicle body 100. Specifically, one side of the support member 500, in the illustrated embodiment, a portion of the rear side, is coupled to the vehicle body 100. The portion of the support member 500 may be fixedly coupled to the vehicle body 100.

The support member 500 is coupled to the actuator 400. Specifically, the one side of the support member, that is, the other portion of the rear side, 500 may be coupled to the actuator 400 and moved in the front and rear directions by the actuator 400.

That is, the support member 500 may be moved by the actuator 400 in the front and rear directions at an angle with respect to the vertical direction.

The support member 500 is coupled with the environment sensor 200. Specifically, the other side of the support member 500, in the illustrated embodiment, the front side, is coupled with the environment sensor 200. The support member 500 may be moved along with the environment sensor 200.

The support member 500 may be provided separately and combined with other components of the vehicle 10. Therefore, the vehicle 10 according to the embodiment of the present disclosure may be configured not only by itself but also by additionally providing the support member 500.

In the illustrated embodiment, the support member 500 includes a bracket member 510, a variable shaft 520, and a fixed shaft 530.

The bracket member 510 is a portion where the support member 500 is coupled to the environment sensor 200. The bracket member 510 is located on the other side, that is, front side and to be coupled to the environment sensor 200 and support it. The bracket member 510 may be moved along with the environment sensor 200.

One portion of the bracket member 510 on the one side, that is, the rear upper side, is coupled to the variable shaft 520. The bracket member 510 may be moved by the variable shaft 520. That is, when the actuator 400 is operated and the variable shaft 520 is moved in the front and rear directions, the bracket member 510 may be moved together in the front and rear directions by the variable shaft 520.

At this time, the bracket member 510 may be rotatably coupled to the variable shaft 520. Accordingly, the bracket member 510 may be moved in the front-back direction and rotated at the same time. Accordingly, the environment sensor 200 coupled to the bracket member 510 may also be rotated.

The other portion of the bracket member 510 on the one side, that is, the rear lower side, is coupled to the fixing shaft 530. The bracket member 510 may be supported by the fixed shaft 530. Among the portions of the bracket member 510, the portion coupled to the fixed shaft 530 is not moved in the front and rear directions.

In this case, the bracket member 510 may be rotatably coupled to the fixed shaft 530. Therefore, even if the upper side of the bracket member 510 is moved in the front and rear directions by the variable shaft 520, the lower side of the bracket member 510 may be rotated in a state where its position in the front and rear directions is fixed by the fixed shaft 530.

The bracket member 510 supports the environment sensor 200 and may be of any shape that may be rotatably coupled to the variable shaft 520 and the fixed shaft 530, respectively. In the illustrated embodiment, the bracket member 510 has a three-dimensional shape with a thickness in the front and back directions and a height in the up and down directions.

The variable shaft 520 is a portion where the support member 500 is coupled to the actuator 400. The variable shaft 520 extends between actuator 400 and bracket member 510. In the illustrated embodiment, the variable shaft 520 extends in the front and rear directions. One side of the variable shaft 520 in the extension direction, in the illustrated embodiment, the rear side is coupled to the actuator 400. The other side of the variable shaft 520 in the extension direction, in the illustrated embodiment, the front side is coupled to the rear upper side of the bracket member 510.

The one side of the variable shaft 520 in the extension direction may be fixedly coupled to the actuator 400 and move together. The other side of the variable shaft 520 in the extension direction may be rotatably coupled to the rear upper side of the bracket member 510. The variable shaft 520 may rotate relative to the bracket member 510 and may be moved in the front and rear directions with the bracket member 510.

The fixing shaft 530 is a portion where the support member 500 is coupled to the vehicle body 100. The fixing shaft 530 extends between the vehicle body 100 and the bracket member 510. In the illustrated embodiment, the fixing shaft 530 extends in the front and rear directions. One side of the fixing shaft 530 in the extending direction, in the illustrated embodiment, the rear side are coupled to the front lower side of the vehicle body 100. The other side of the fixing shaft 530 in the extending direction, in the illustrated embodiment, the front side are coupled to the rear lower side of the bracket member 510.

The one side of the fixing shaft 530 in the extending direction may be fixedly coupled to the vehicle body 100. The other side of the fixing shaft 530 in the extending direction may be rotatably coupled to the rear lower side of the bracket member 510. The fixing shaft 530 may rotatably support the bracket member 510.

The controller 600 receives environment detection information generated by the environment sensor 200 and inclination detection information generated by the inclination sensor 300. The controller 600 may calculate control information for controlling the actuator 400 using the received environment detection information and inclination detection information. The controller 600 may control the actuator 400 corresponding to the calculated control information. The controller 600 is electrically connected to the environment sensor 200, the inclination sensor 300, and the actuator 400, respectively.

Additionally, the controller 600 may be electrically connected to other components provided in the vehicle 10, that is, any components provided for driving. The controller 600 may use environment detection information and inclination detection information to calculate control information for controlling the other components.

The controller 600 may be provided in any form capable of inputting, calculating, and outputting information. In one embodiment, the controller 600 may be provided in the form of any electronic device including a CPU or microprocessor.

The controller 600 may calculate control information for adjusting the direction in which the detecting area (A) faces using the received environment detection information and inclination detection information.

That is, as shown in FIGS. 2 to 4, the controller 600 may operate the actuator 400 corresponding to the calculated control information. Accordingly, the angle of the environment sensor 200 and the detecting area (A) detected by the environment sensor 200 may be adjusted to any one of the first position (P1), the second position (P2), and the third position (P3).

In the following description, it is assumed that the flat surface (F) refers to a surface that is flat enough not to affect the driving angle of the vehicle 10, the first slope surface (S1) refers to an uphill surface, and the second slope surface (S2) refers to a downhill surface.

First, as shown in FIG. 2, the controller 600 may control the actuator 400 to move and maintain the environment sensor 200 to the first position (P1). In this state, the bracket member 510 and the environment sensor 200 coupled thereto may be moved and maintained at a predetermined angle with respect to the ground. In one embodiment, the predetermined angle may be 0°.

The first position (P1) may be formed when the vehicle 10 driving on one of the flat surface (F), the first slope surface (S1) and the second slope surface (S2) enters the same surface (F, S1, and S2). That is, the first position (P1) is formed when the vehicle 10 is driving on a continuous flat surface (F), a continuous first slope surface (S1), and a continuous second slope surface (S2).

In other words, when the vehicle 10 continues to drive on the flat surface (F), sufficiently accurate environment detection information may be generated even if the detection area (A) that may be detected by the environment sensor 200 does not move.

In addition, when the vehicle 10 enters the first slope surface (S1) or the second slope surface (S2), the vehicle 10 is driving in a state in which it is inclined corresponding to the first slope surface (S1) or the second slope surface (S2), so a movement of the detecting area (A) is not required.

Accordingly, when the environment detection information generated by the environment sensor 200 means that the same surfaces (F, S1, and S2) are located on the front side, the controller 600 calculates the control information so that the environment sensor 200 is moved and maintained at the first position (P1), and controls the actuator 400 accordingly.

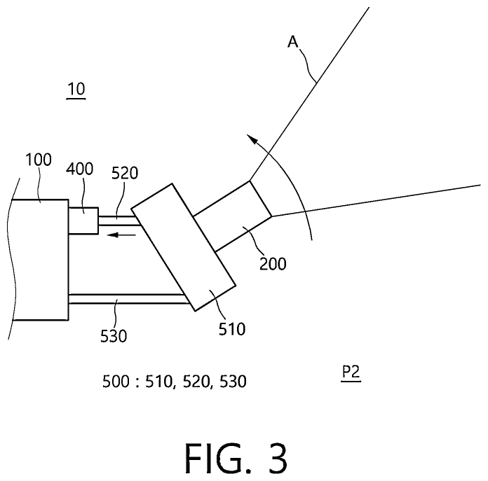

Referring to FIG. 3, the controller 600 may control the actuator 400 to move and maintain the environment sensor 200 to the second position (P2). In this state, the bracket member 510 and the environment sensor 200 coupled thereto may be moved and maintained at different angles opposite to the ground.

The second position (P2) may be formed when the vehicle 10 being driven on the flat surface (F) enters the first slope surface (S1) or when the vehicle 10 being driven on the second slope surface (S2) enters the flat surface (F) or the first slope surface (S1). That is, the second position (P2) is formed when the angle formed by the surface on which the vehicle 10 will be driven later increases in the upward direction compared to the surface on which the vehicle 10 is currently driven.

That is, when the vehicle 10 being driven on the flat surface (F) enters the first slope surface (S1), an area (specifically, an upper area) that is partially excluded from the detecting area (A) among the front areas of the vehicle 10 may be generated as the angle of the vehicle 10 is changed.

Likewise, when the vehicle 10 being driven on the second slope surface (S2) enters the flat surface (F) or the first slope surface (S1), an area (specifically, an upper area) that is partially excluded from the detecting area (A) among the front areas of the vehicle 10 may be generated as the angle of the vehicle 10 is changed.

Accordingly, the environment detection information generated by the environment sensor 200 means that the surface located on the front side is inclined upward compared to the surface currently being driven, the controller 600 calculates control information so that the environment sensor 200 is tilted upward and is moved and maintained at the second position (P2), and controls the actuator 400 accordingly.

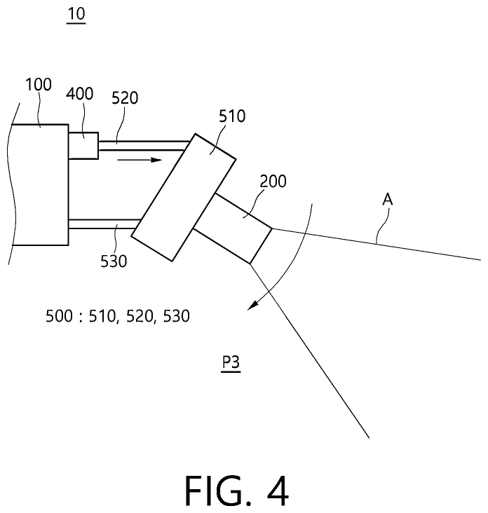

Referring to FIG. 4, the controller 600 may control the actuator 400 to move and maintain the environment sensor 200 to the third position (P3). In this state, the bracket member 510 and the environment sensor 200 coupled thereto may be moved and maintained at another angle toward the ground.

The third position (P3) may be formed when the vehicle 10 being driven on the flat surface (F) enters the second slope surface (S2) or when the vehicle 10 being driven on the first slope surface (S1) enters the flat surface (F) or the second slope surface (S2). That is, the third position (P3) is formed when the angle formed by the surface on which the vehicle 10 will be driven later increases in the downward direction compared to the surface on which the vehicle 10 is currently driven.

That is, when the vehicle 10 being driven on the flat surface (F) enters the second slope surface (S2), an area (specifically, a lower area) that is partially excluded from the detecting area (A) among the front areas of the vehicle 10 may be generated as the angle of the vehicle 10 is changed.

Likewise, when the vehicle 10 being driven on the first slope surface (S1) enters the flat surface (F) or the second slope surface (S2), an area (specifically, a lower area) that is partially excluded from the detecting area (A) among the front areas of the vehicle 10 may be generated as the angle of the vehicle 10 is changed.

Accordingly, the environment detection information generated by the environment sensor 200 means that the surface located on the front side is inclined downward compared to the surface currently being driven, the controller 600 calculates control information so that the environment sensor 200 is tilted upward and is moved and maintained at the third position (P3), and controls the actuator 400 accordingly.

In addition, as described above, the controller 600 may calculate control information for controlling the actuator 400 by further utilizing inclination detection information on the slope generated by the inclination sensor 300.

That is, the controller 600 may calculate whether the vehicle 10 enters the surface located in the front side using the inclination detection information generated by the inclination sensor 300. When the vehicle 10 completely enters the surface, the controller 600 calculates control information so that the environment sensor 200 is moved and maintained again in the first position (P1), and controls the actuator 400 accordingly.

Specifically, when it is calculated that the vehicle 10 has entered the flat surface (F) or the first slope surface (S1) after the environment sensor 200 is moved and maintained at the second position (P2), the controller 600 calculates control information so that the environment sensor 200 is tilted downward and returns to the first position (P1), and controls the actuator 400 accordingly.

In addition, when it is calculated that the vehicle 10 has entered the flat surface (F) or the second slope surface (S2) after the environment sensor 200 is moved and maintained at the third position (P3), the controller 600 calculates control information so that the environment sensor 200 is tilted upward and returns to the first position (P1), and controls the actuator 400 accordingly.

On the other hand, when the environment detection information generated by the environment sensor 200 and the inclination detection information generated by the inclination sensor 300 conflict, the controller 600 may calculate control information by prioritizing the environment detection information generated by the environment sensor 200.

For example, if an unevenness or speed bump, etc. is formed on the road surface on which the vehicle 10 is driven, despite the vehicle 10 being scheduled to continue being driven on the same surface (F, S2, and S2), the inclination detection information generated by the inclination sensor 300 may mean that the vehicle 10 is scheduled to be driven on a different surface from the currently traveling surface.

In this case, since the position of the environment sensor 200 does not need to be changed, the controller 600 may calculate control information by prioritizing the environment detection information generated by the environment sensor 200, that is, the environment detection information on the surfaces (F, S1, and S2) located in the front side.

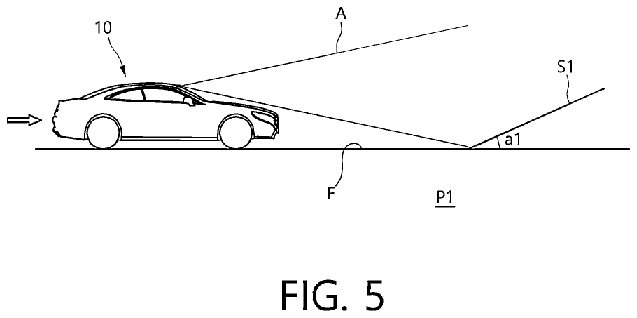

Referring to FIGS. 5 to 10, a process of changing the position of the environment sensor 200 and the detecting area (A) through the above-described process is illustrated as an example.

In the embodiment shown in FIGS. 5 to 7, the vehicle 10 is driven on the flat surface (F), and then enters the first slope surface (S1). It will be understood that the above embodiment may be equally applied to the case where the vehicle 10 is driven on the second slope surface (S2) and then enters the flat surface (F) or the first slope surface (S1).

Referring to FIG. 5, the vehicle 10 is driven on the flat surface (F). At this time, the environment sensor 200 detects that the first slope surface (S1) that extends inclined upwardly by a first angle (a1) exists in the front side of the vehicle 10. The environment detection information generated by the environment sensor 200 is transmitted to the controller 600.

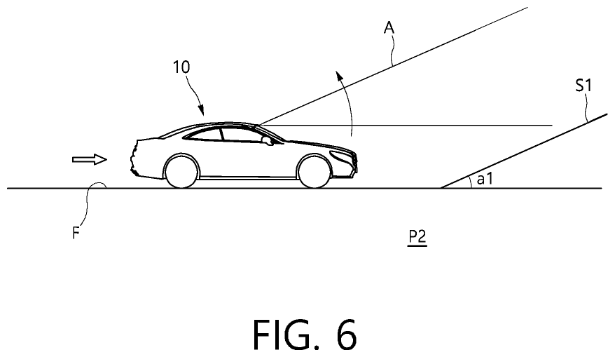

Referring to FIG. 6, the vehicle 10 is driven to a position adjacent to the boundary between the flat surface (F) and the first slope surface (S1). The controller 600 uses the environment detection information generated by the environment sensor 200 to calculate control information for controlling the actuator 400. The controller 600 controls the actuator 400 according to the calculated control information.

The actuator 400 is operated to move the variable shaft 520 and the bracket member 510 coupled thereto to the rear side. Accordingly, the environment sensor 200 is tilted upward and adjusted to the second position (P2).

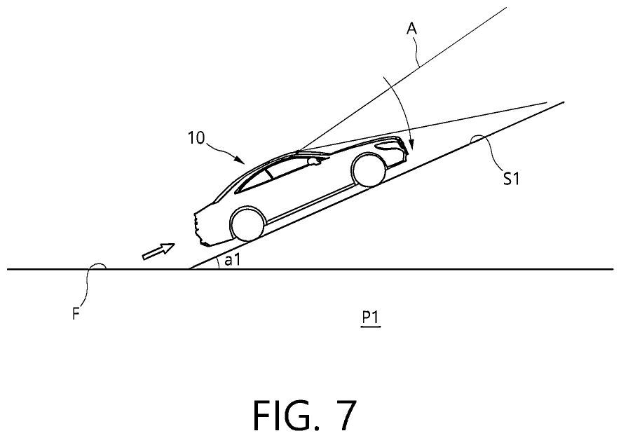

Referring to FIG. 7, the vehicle 10 completely enters the first slope surface (S1). The controller 600 calculates control information for controlling the actuator 400 by further using the inclination detection information generated by the inclination sensor 300. The controller 600 controls the actuator 400 according to the calculated control information.

Accordingly, the actuator 400 is operated to move the variable shaft 520 and the bracket member 510 coupled thereto to the front side. Accordingly, the environment sensor 200 is tilted downward and adjusted to the first position (P1).

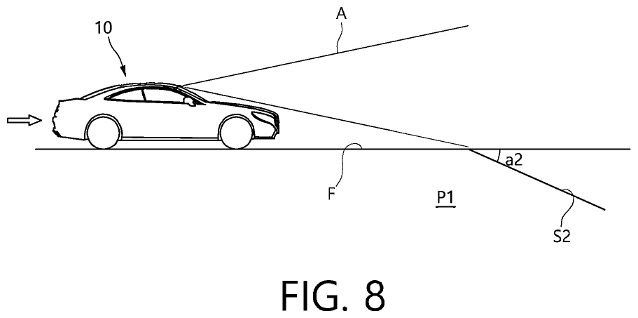

In the embodiment shown in FIGS. 8 to 10, the vehicle 10 is driven on the flat surface (F), and then enters the second slope surface (S2). It will be understood that the above embodiment may be equally applied to the case where the vehicle 10 is driven on the first slope surface (S1) and then enters the flat surface (F) or the second slope surface (S2).

Referring to FIG. 8, the vehicle 10 is driven on the flat surface (F). At this time, the environment sensor 200 detects that the second slope surface (S2) that extends inclined downward by a second angle (a2) exists in the front side of the vehicle 10. The environment detection information generated by the environment sensor 200 is transmitted to the controller 600.

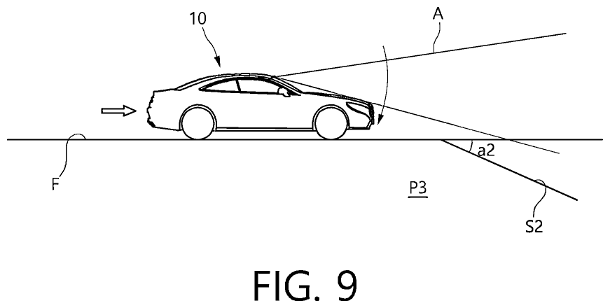

Referring to FIG. 9, the vehicle 10 is driven to a position adjacent to the boundary between the flat surface (F) and the second slope surface (S2). The controller 600 uses the environment detection information generated by the environment sensor 200 to calculate control information for controlling the actuator 400. The controller 600 controls the actuator 400 according to the calculated control information.

The actuator 400 is operated to move the variable shaft 520 and the bracket member 510 coupled thereto to the front side. Accordingly, the environment sensor 200 is tilted downward and adjusted to the third position (P3).

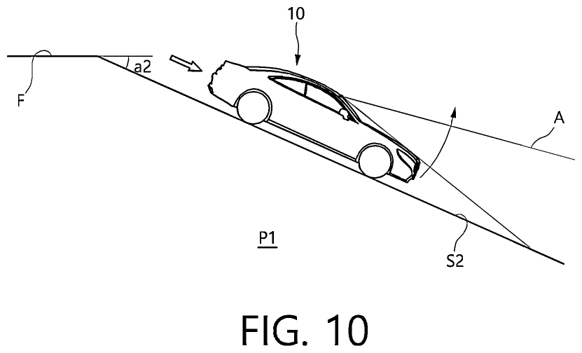

Referring to FIG. 10, the vehicle 10 completely enters the second slope surface (S2). The controller 600 calculates control information for controlling the actuator 400 by further using the inclination detection information generated by the inclination sensor 300. The controller 600 controls the actuator 400 according to the calculated control information.

The actuator 400 is operated to move the variable shaft 520 and the bracket member 510 coupled thereto to the rear side. Accordingly, the environment sensor 200 is tilted upward and adjusted to the first position (P1).

Accordingly, in the vehicle 10 according to an embodiment of the present disclosure, the environment sensor 200 may be adjusted to any one of the second and third positions (P2, and P3) immediately before entering the driving surface (F, S1, and S2). Additionally, after the vehicle 10 enters the driving surface (F, S1, and S2), the environment sensor 200 may be adjusted to the first position (P1) again in accordance with the inclination detection information generated by the inclination sensor 300.

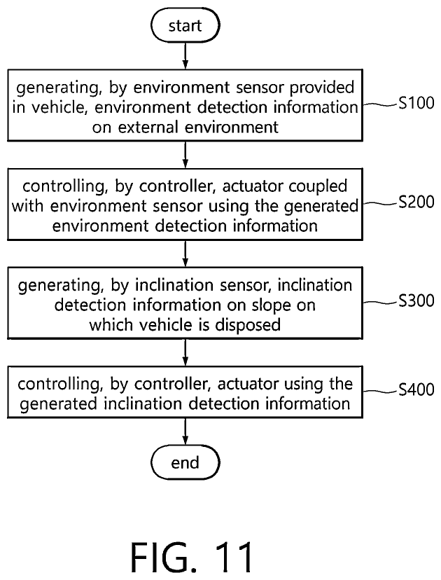

Referring to FIGS. 11 to 14, a flow of a method of controlling a vehicle 10 according to an embodiment of the present disclosure is illustrated as an example. The method of controlling the vehicle 10 according to the illustrated embodiment may be performed by each component of the vehicle 10.

In an embodiment illustrated in FIG. 11, the method for controlling the vehicle 10 includes generating, by an environment sensor 200 provided in the vehicle 10, environment detection information on an external environment (step S100), controlling, by a controller, an actuator 400 coupled with the environment sensor 200 using the generated environment detection information 600 (step S200), generating, by an inclination sensor 300, inclination detection information on an angle on which the vehicle 10 is disposed (step S300), and controlling, by the controller 600, the actuator 400 using the generated inclination detection information (step S400).

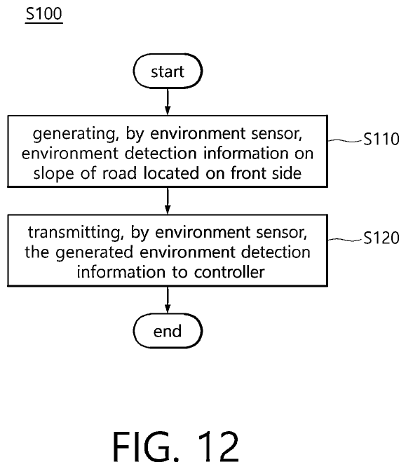

Referring to FIG. 12, a detailed flow of the step S100 of generating, by an environment sensor 200 provided in the vehicle 10, environment detection information on an external environment is shown as an example. The present step S100 is a step in which the environment sensor 200 generates environment detection information on a surface which the vehicle 10 will enter.

First, the environment sensor 200 generates environment detection information on a slope of the road located on front side of the vehicle 10 (step S110). The environment detection information generated by the environment sensor 200 may be one of a flat surface (F), a first slope surface (S1), and a second slope surface (S2). The environment sensor 200 transmits the generated inclination detection information to the controller 600 (step S120).

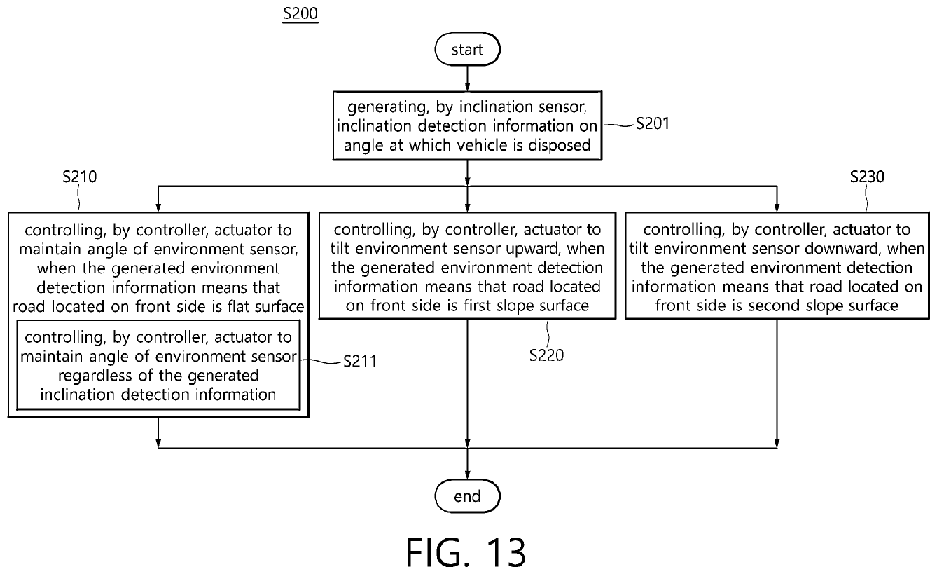

Referring to FIG. 13, a detailed flow of the step S200 of controlling, by a controller, an actuator 400 coupled with the environment sensor 200 using the generated environment detection information 600 is shown as an example. The present step S200 is a step in which the controller 600 controls the actuator 400 so that the position of the detecting area (A) formed by the environment sensor 200 is adjusted.

At this time, a step S201 in which the inclination sensor 300 generates inclination detection information on an angle at which the vehicle 10 is disposed may be preceded.

When the environment detection information generated by the environment sensor 200 means that a road located on the front side is the flat surface (F), the controller 600 controls the actuator 400 to maintain the angle of the environment sensor 200 (step S210). Accordingly, the environment sensor 200 may be maintained at the first position (P1). In other words, The present step S210 may be performed when the height of the environment sensor 200 and the detecting area (A) formed thereby does not need to be changed.

In the illustrated embodiment, it is assumed that the surface on which the vehicle 10 is currently driven is the flat surface (F). Although not shown, the present step S210 may be performed even when the surface on which the vehicle 10 is currently driven is the first slope surface (S1) and the generated environment detection information means the first slope surface (S1). Furthermore, it will be understood that the present step S210 may be performed in the same manner even when the surface on which the vehicle 10 is currently driven is the second slope surface (S2) and the generated environment detection information means the second slope surface (S2).

On the other hand, when an unevenness or the like exists on the ground on which the vehicle 10 is driven, the inclination detection information generated by the inclination sensor 300 and the environment detection information generated by the environment sensor 200 may be different.

In this case, the controller 600 may control the actuator 400 to maintain the angle of the environment sensor 200 regardless of the generated inclination detection information (step S211). That is, when the generated environment detection information and the generated inclination detection information conflict, the controller 600 may calculate control information by prioritizing the environment detection information.

In addition, when the environment detection information generated by the environment sensor 200 means that a road located on the front side is the first slope surface (S1), the controller 600 controls the actuator 400 to tilt the environment sensor 200 upward (step S220). Accordingly, the environment sensor 200 may be moved and maintained at the second position (P2). In other words, The present step S220 may be performed when the environment sensor 200 and the detecting area (A) formed thereby need to be moved upward.

In the illustrated embodiment, it is assumed that the surface on which the vehicle 10 is currently driven is the flat surface (F). Although not shown, it will be understood that the present step S220 may be performed even when the vehicle 10 is currently driven the second slope surface (S2), and the generated environment detection information means the flat surface (F) or the first slope surface (S1).

Furthermore, when the environment detection information generated by the environment sensor 200 means that a road located on the front side is the second slope surface (S2), the controller 600 controls the actuator 400 to tilt the environment sensor 200 downward (step S230). Accordingly, the environment sensor 200 may be moved and maintained at the third position (P3). In other words, The present step S230 may be performed when the environment sensor 200 and the detecting area (A) formed thereby need to be moved downward.

In the illustrated embodiment, it is assumed that the surface on which the vehicle 10 is currently driven is the flat surface (F). Although not shown, it will be understood that the present step S230 may be performed even when the vehicle 10 is currently driven the first slope surface (S1) and the generated environment detection information means the flat surface (F) or a second slope surface (S2).

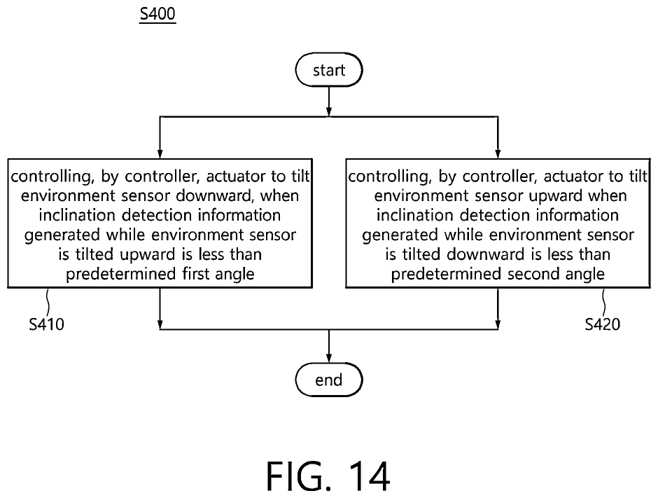

Referring to FIG. 14, a detailed flow of the step S400 of controlling, by the controller 600, the actuator 400 using the generated inclination detection information is shown as an example. The present step S400 is a step in which the actuator 400 is controlled so that the environment sensor 200 is returned to the first position (p1) again after the vehicle 10 enters a surface located on the front side.

When the inclination detection information generated while the environment sensor 200 is tilted upward is less than the predetermined first angle (a1), the controller 600 controls the actuator 400 to tilt the environment sensor 200 downward (step S410). Accordingly, the environment sensor 200, which has been moved and maintained at the second position (P2), may be moved and maintained at the first position (P1).

That is, the present step S410 may be performed when the vehicle 10 driven on the flat surface (F) completely enters the first slope surface (S1), or when the vehicle 10 driven on the second slope surface (S2) completely enters the flat surface (F) or the first slope surface (S1).

Meanwhile, the predetermined first angle (a1) may be defined as an angle of a minimum size in which it may be determined that the surface into which the vehicle 10 is completely entered extends inclined upward compared to the surface on which the vehicle 10 is previously driven. In other words, the first angle (a1) may be defined as an angle of a maximum size at which the vehicle 10 may be determined to be driven on a surface having the same slope.

Therefore, when the inclination detection information generated by the inclination sensor 300 is less than the first angle (a1), the vehicle 10 may be considered to have completely entered the uphill surface. Accordingly, the controller 600 controls the actuator 400 so that the environment sensor 200 adjusted to the second position (P2) is adjusted to the first position (P1) again.

When the inclination detection information generated while the environment sensor 200 is tilted downward is less than the predetermined second angle (a2), the controller 600 controls the actuator 400 to tilt the environment sensor 200 upward (step S420). Accordingly, the environment sensor 200, which has been moved and maintained at the third position (P3), may be moved and maintained at the first position (P1).

That is, the present step S420 may be performed when the vehicle 10 driven on the flat surface (F) completely enters the second slope surface (S2), or when the vehicle 10 driven on the first slope surface (S1) completely enters the flat surface (F) or the second slope surface (S2).

Meanwhile, the predetermined second angle (a2) may be defined as an angle of a minimum size in which it may be determined that the surface into which the vehicle 10 is completely entered extends inclined downward compared to the surface on which the vehicle 10 is previously driven. In other words, the second angle (a2) may be defined as an angle of a maximum size at which the vehicle 10 may be determined to be driven on a surface having the same slope.

Therefore, when the inclination detection information generated by the inclination sensor 300 is less than the second angle (a2), the vehicle 10 may be considered to have completely entered the downhill surface. Accordingly, the controller 600 controls the actuator 400 so that the environment sensor 200 adjusted to the third position (P3) is adjusted to the first position (P1) again.

Although the embodiments of the present disclosure are described, the spirit of the present disclosure is not limited by the embodiments presented in the specification, and those skilled in the art who understand the spirit of the present disclosure can easily propose other embodiments by adding, changing, deleting, and adding components within the same spirit, but this is also within the spirit of the present disclosure.

### LIST OF REFERENCE SIGNS

10: vehicle
100: vehicle body
200: environment sensor
300: inclination sensor
400: actuator
500: support member
510: bracket member
520: variable shaft
530: fixed shaft
600: controller
A: detecting area
F: flat surface
P1: first position
P2: second position
P3: third position
S1: first slope
S2: second slope
a1: first angle
a2: second angle

What is claimed is:

1. A vehicle, comprising:
a vehicle body;
an environment sensor configured to generate environment detection information on an external environment;
a support member coupled to the vehicle body and the environment sensor, respectively; and
an actuator coupled to the vehicle body and one part of the support member, respectively, and configured to move the one part of the support member in a direction toward the vehicle body and a direction opposite to the vehicle body,
wherein one side of the support member in a height direction is coupled to the actuator, and the other side of the support member in the height direction is rotatably coupled to the vehicle body, so that when the actuator is operated, the environment sensor rotates clockwise or counterclockwise about the other side of the support member.

2. The vehicle of claim 1, wherein the support member includes:
a bracket member coupled to the environment sensor;
a variable shaft coupled to one side of the bracket member in the height direction and the actuator, respectively; and
a fixed shaft coupled to the other side of the bracket member in the height direction and the vehicle body, respectively.

3. The vehicle of claim 2, wherein the variable shaft and the fixed shaft are rotatably coupled to the bracket member, respectively, and
the environment sensor is fixedly coupled to the bracket member to rotate clockwise or counterclockwise about a portion where the fixed shaft and the bracket member are coupled.

4. The vehicle of claim 1, comprising:
a controller electrically connected to the environment sensor and the actuator, respectively, and configured to control the actuator using the generated environment detection information.

5. The vehicle of claim 4, wherein the controller control the actuator to move the support member in a direction toward the vehicle body such that the environment sensor is tilted upward when the generated environment detection information means that a first slope surface is located on a front side.

6. The vehicle of claim 5, comprising:
an inclination sensor electrically connected to the controller and configured to generate inclination detection information on a slope of a surface on which the vehicle is located,
wherein the controller controls the actuator to move the support member in a direction opposite to the vehicle body such that the environment sensor is tilted downward when the inclination detection information generated after entering the first slope surface is less than a predetermined first angle.

7. The vehicle of claim 4, wherein the controller controls the actuator to move the support member in a direction opposite to the vehicle body such that the environment sensor is tilted downward when the generated environment detection information means that a second slope surface is located on a front side.

8. The vehicle of claim 7, comprising:
an inclination sensor electrically connected to the controller and configured to generate inclination detection information on a slope of a surface on which the vehicle is located,
wherein the controller controls the actuator to move the support member in a direction toward the vehicle body such that the environment sensor is tilted upward when the inclination detection information generated after entering the second slope surface is less than a predetermined second angle.

9. The vehicle of claim 4, comprising:
an inclination sensor electrically connected to the controller and configured to generate inclination detection information on a slope of a surface on which the vehicle is located,
wherein the controller calculates control information for controlling the actuator using only the environment detection information when the generated environment detection information means that a flat surface is located on a front side, and the generated inclination detection information means that a first slope surface or a second slope surface is located on the front side.

10. The vehicle of claim 1, wherein the environment sensor includes one or more of a LIDAR sensor, a camera sensor, and a 4D imaging radar sensor.

11. A method of controlling a vehicle, comprising:
(a) generating, by an environment sensor provided in a vehicle, environment detection information on an external environment;
(b) controlling, by a controller, an actuator coupled with the environment sensor using the generated environment detection information;
(c) generating, by an inclination sensor, inclination detection information on a slope on which the vehicle is disposed; and
(d) controlling, by the controller, the actuator using the generated inclination detection information.

12. The method of claim 11, wherein the step (a) includes:
(a1) generating, by the environment sensor, the environment detection information on a slope of a road located on a front side thereof; and
(a2) transmitting, by the environment sensor, the generated environment detection information to the controller.

13. The method of claim 11, wherein the step (b) includes:
(b1) controlling, by the controller, the actuator to maintain an angle of the environment sensor, when the generated environment detection information means that a road located on a front side is a flat surface;
(b2) controlling, by the controller, the actuator to tilt the environment sensor upward, when the generated environment detection information means that a road located on a front side is a first slope surface; and
(b3) controlling, by the controller, the actuator to tilt the environment sensor downward, when the generated environment detection information means that a road located on a front side is a second slope surface.

14. The method of claim 13, wherein the step (b) further includes before the steps (b1) to (b3):
(b0) generating, by the inclination sensor, the inclination detection information on an angle at which the vehicle is disposed, and
wherein the step (b1) includes:
(b11) controlling, by the controller, the actuator to maintain the angle of the environment sensor regardless of the generated inclination detection information.

15. The method of claim 11, wherein the step (d) includes:
(d1) controlling, by the controller, the actuator to tilt the environment sensor downward, when the inclination detection information generated while the environment sensor is tilted upward is less than a predetermined first angle; and
(d2) controlling, by the controller, the actuator to tilt the environment sensor upward when the inclination detection information generated while the environment sensor is tilted downward is less than a predetermined second angle.
